(19) United States
(12) Patent Application Publication
(10) Pub. No.: US 2025/0297519 A1
(43) Pub. Date: Sep. 25, 2025

(54) Multifunctional and Adjustable Ladder Support Device

(71) Applicant: Israel Tanenbaum, Los Angeles, CA (US)

(72) Inventor: Israel Tanenbaum, Los Angeles, CA (US)

(21) Appl. No.: 18/612,810

(22) Filed: Mar. 21, 2024

(51) Int. Cl. E06C 7/48

(52) U.S. Cl. CPC E06C 7/488

(57) ABSTRACT

The multifunctional ladder support device is intended to provide users with an adjustable accessory for different kinds of ladders. More specifically, the device is a permanent attachment to a ladder that enables users to use the attachment as a roof standoff, wall standoff, ladder stabilizer, etc. To accomplish this, the device includes a plurality of arm structures attached to the plurality of side rails of the ladder. Each of the arm structures have multiple pieces and connectors that help to extend the arm structures in different directions and angles, to achieve the intended functionalities. Further, the device may be stowed in a retracted mode, without hindering any functionalities of the ladder. Furthermore, the arm structures have holes to thread through external fasteners, thereby providing additional support and stability features to the ladder system. Thus, the device is a simple and efficient accessory and safety attachment for ladders.

### FIELD OF THE INVENTION

The present invention relates generally to a ladder support device. More specifically, the invention relates to an accessory device that may be installed on different types of ladders to provide a wide range of functionalities.

### BACKGROUND OF THE INVENTION

There are many varieties of ladders available in the market that may be used in different ways or modes. Some examples include multi-position ladders with modes such as extension ladder mode, frame ladder mode, scaffolding mode, etc. Ladders oftentimes require support structures such as roof stand offs, stabilizers, corner stabilizers, stand offs around windows or walls etc. when used in the extension mode. However, most of such support structures or products found in the current market are large-sized separate components that need to be attached to the rungs of the ladder and bolted together either with pins, brackets, and/or bolts. Further, if a consumer wishes to switch the ladder to A-frame mode, they will need to completely remove the attachment and store the attachment away from the ladder. However, a ladder with an inbuilt attachment that can perform multiple functions without hindering the ladder's different modes of operations is a rare find in the current market.

An objective of the present invention is to provide users with an adjustable and multifunctional ladder support device. More specifically, the present invention is a permanent attachment to a ladder that helps users to use the ladder as a roof standoff, wall standoff, ladder stabilizer etc. Thus, the present invention is a simple and efficient accessory and safety attachment for ladders.

### SUMMARY OF THE INVENTION

The multifunctional ladder support device is intended to provide users with an adjustable accessory for different kinds of ladders. More specifically, the present invention is a permanent attachment to a ladder that helps users to use the attachment as a roof standoff, wall standoff, ladder stabilizer, etc. while using the ladder in different modes. To accomplish this, the present invention comprises a plurality of arm structures attached to the plurality of side rails of the ladder. Each of the arm structures have multiple pieces and connectors that help to extend the arm structures in different shapes and angles, to achieve the intended functionalities. Further, the present invention may be stowed in a retracted mode when not needed, without hindering any functionalities of the ladder. Furthermore, the arm structures have holes to thread through external fasteners, thereby providing additional support and stability features to the ladder system. Thus, the present invention is a simple and efficient accessory and safety attachment for ladders.

### BRIEF DESCRIPTION OF THE DRAWINGS

FIG. 1 is a top-front-left perspective view of the present invention.

FIG. 2 is a detailed view of section 2 of FIG. 1.

FIG. 3 is a top-rear-left perspective view of the present invention, wherein the plurality of arm structures is in an extended configuration normal to the side rails of the ladder.

FIG. 4 is a right-side elevational view of the present invention in an extended configuration.

FIG. 5 is a detailed view of section 5 of FIG. 4.

FIG. 6 is a right-side elevational view of the present invention, wherein the plurality of arm structures is in the extended configuration parallel to the side rails of the ladder.

FIG. 7 is a right-side elevational view of the present invention, wherein a second section of the arm structure is angularly offset from the first section of the arm structure.

FIG. 8 is a top elevational view of the present invention in the extended configuration.

FIG. 9 is a top elevational view of the present invention, wherein the second section is angularly offset from the first section and is oriented towards the center of the ladder.

FIG. 10 is a right-side elevational view of a ladder device in A-frame mode, wherein a fastener is threaded through a hole in the arm structure.

### DETAIL DESCRIPTIONS OF THE INVENTION

All illustrations of the drawings are for the purpose of describing selected versions of the present invention and are not intended to limit the scope of the present invention.

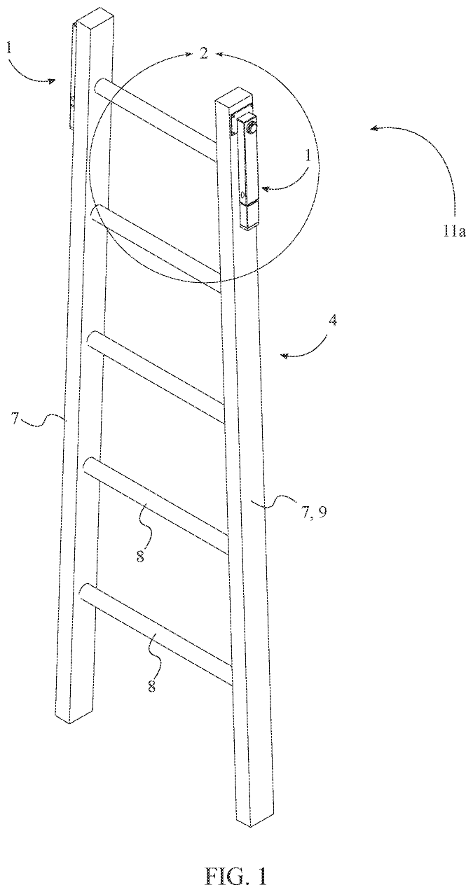

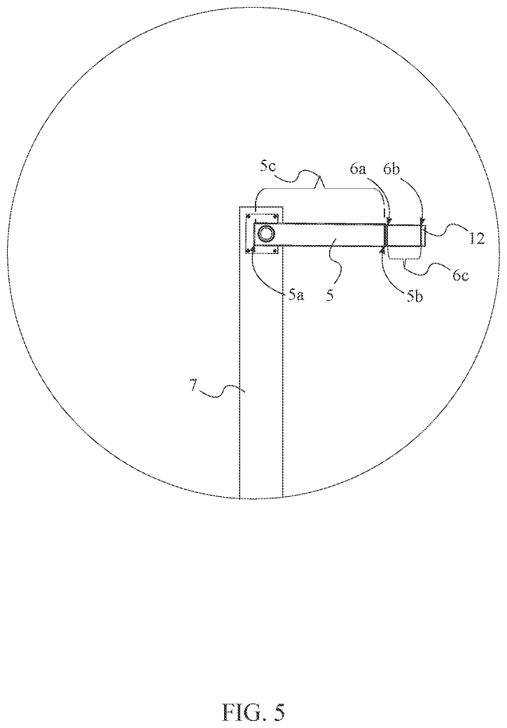

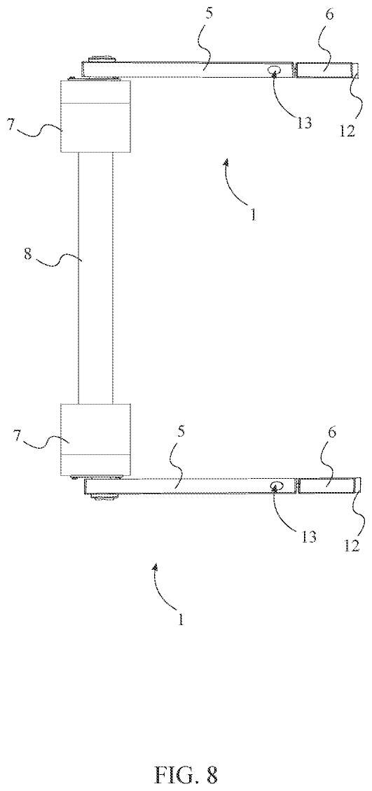

In reference to FIG. 1 through FIG. 10, the present invention is a multifunctional ladder support device.

The following description is in reference to FIG. 1 through FIG. 10. According to a preferred embodiment, the present invention comprises a plurality of main arms 1, a plurality of mounting members 2, a plurality of connecting members 3, and a ladder 4. The plurality of arms 1 is preferably made of Aluminum and is rectangular in shape. The plurality of mounting members 2 are attachment plates or fastening elements that help to connect the plurality of arms 1 onto the ladder 4. Further, the plurality of connecting members 3 comprise hinges and/or other connectors that enable flexible joints or access to move in different directions, to enable the indented functionalities of the present invention. The ladder 4 is preferably a multi-position ladder or an extension ladder. However, it should be noted that, the main arms 1, the mounting member 2, the connecting members 3, and the ladder 4 may comprise any other material, size, shape, components, arrangement of components, etc. that are known to one of ordinary skill in the art, as long as the intents of the present invention are not altered.

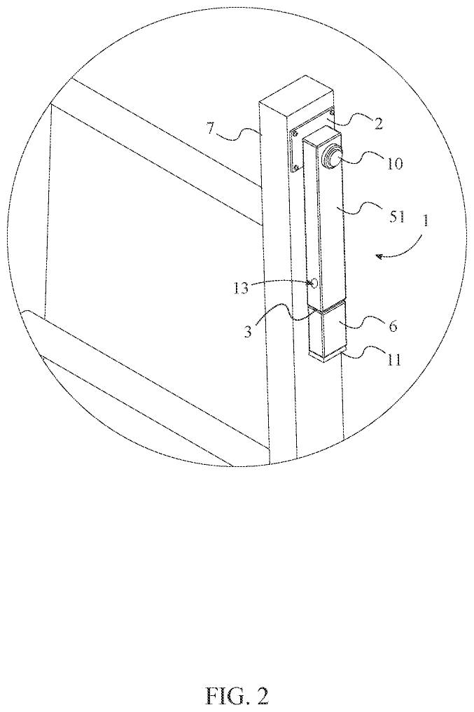

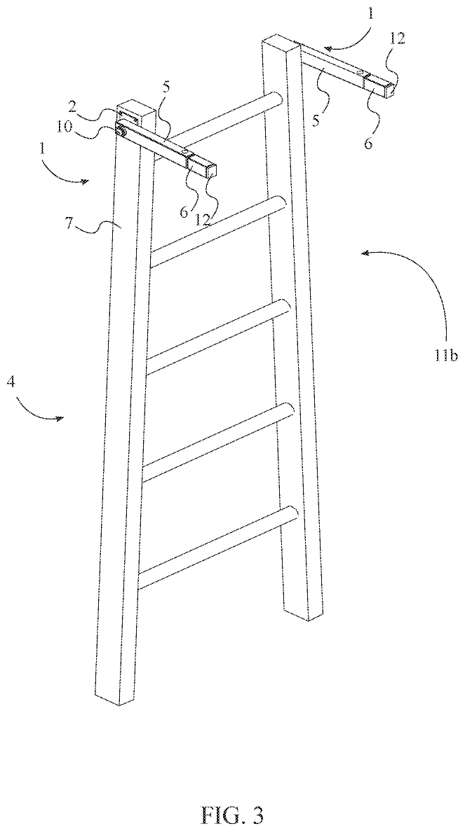

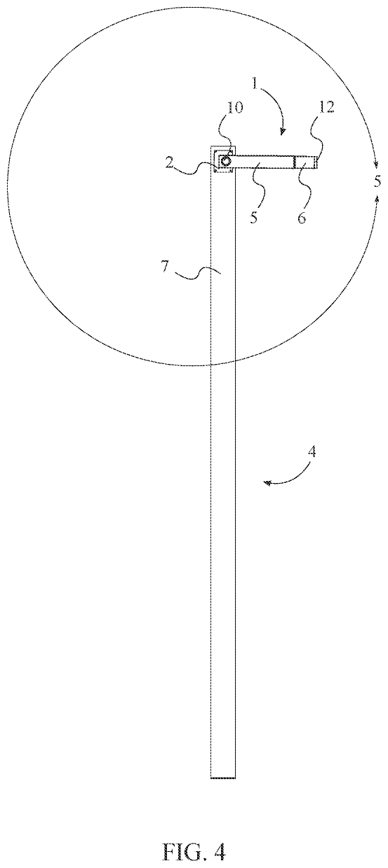

In the preferred embodiment, each of the plurality of main arms 1 comprises a first section 5 and a second section 6. As seen in FIG. 1 through FIG. 10, the first section 5 comprises a first end 5a and a second end 5b, wherein the first end 5a is positioned opposite to the second end 5b across a first length 5c of the first section 5, and the second section 6 comprises a third end 6a and a fourth end 6b, wherein the third end 6a is positioned opposite to the fourth end 6b across a second length 6c of the second section 6. In other words, the first section 5 is the longer segment of each of the plurality of main arms 1, that is mounted to the ladder 4, and the second section 6 is the shorter segment that terminally mounted to the first section 5. Further, the first end 5a and the second end 5b constitute two terminal ends of the first section 5 and the third end 6a, and the fourth end 6b constitute two terminal ends of the second section 6. As seen in FIG. 1 and FIG. 3, the ladder 4 comprises a plurality of side rails 7. More specifically, the ladder 4 comprises a plurality of side rails 7 that are connected together by a plurality of steps 8 in between. Further, each of the plurality of the mounting members 2 is mounted between the first section 5 of the main arm 1 and a corresponding side rail 9, wherein the corresponding side rail 9 is from the plurality of side rails 7. In other words, the plurality of main arms 1 is attached to the ladder 4 with the help of the mounting members 2. Preferably, the plurality of main arms 1 are mounted adjacent to a terminal end of the ladder 4. As seen in FIG. 2 and FIG. 4, each of the plurality of mounting members 2 is a metal piece with a plurality of screws and rotators. It is an aim of the present invention to use the plurality of main arms 1 in different directions for different purposes. To that end, the plurality of main arms 1 is rotatably connected to the ladder 4 through the plurality of mounting members 2. Similarly, each of the plurality of the connecting members 3 is integrated between the second end 5b of the first section 5 and the third end 6a of the second section 6. Preferably, each of the plurality of connection members 3 is a pivot hinge. However, the mounting members 2 and the connecting members 3 may comprise any other shape, technology, material, etc., that are known to one of ordinary skill in the art, as long as the objectives of the present invention are fulfilled.

It is an objective of the present invention to be used for multiple uses and hence in multiple positions. To accomplish this, the present invention comprises a locking mechanism 10. Preferably, the locking mechanism 10 is operably integrated between the main arm 1 and the ladder 4 through the mounting member 2, wherein operating the locking mechanism 10 enables locking the main arm 1 in a plurality of different positions with respect to the plurality of siderails 7 of the ladder 4. Preferably, the locking mechanism 10 comprises a push button or push pin that allows the user to lock the plurality of main arms 1 on different positions. However, the locking mechanism 10 may comprise any other locking and releasing technology that is known to one of ordinary skill in the art, as long as the intents of the present invention are not hindered.

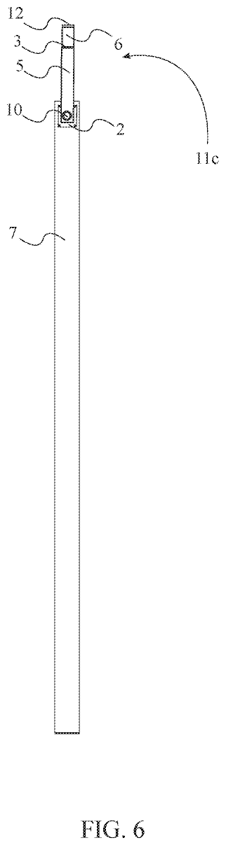

In reference to FIG. 1 and FIG. 2, the locking mechanism 10 locks the main arm 1 in a first position 11a, wherein the main arm is oriented parallel to the plurality of side rails. This is a stowed position or rest position where the plurality of main arms 1 is not used. In reference to FIG. 3 through FIG. 5, the locking mechanism 10 locks the main arm 1 in a second position 11b, wherein the main arm 1 is oriented normally to the plurality of side rails 7 in this position. In the second position 11b, the device may be used as a wall standoff, which would allow the user to set up the ladder at walls or windows to gain safe access to complete a task at hand. In reference to FIG. 6, the locking mechanism 10 locks the main arm 1 in a third position 11c, wherein the main arm 1 extends in a direction away from the plurality of side rails 7 and is positioned parallel to the plurality of side rails 7. This position allows the user to use the invention as a roof standoff, which would allow the user to set up the ladder at the roof edge, without leaning the ladder against gutter, fascia, overhang or any scratch/dent prone portion of the property.

It is an aim of the present invention to provide support and stability for the ladder when used at various locations and environments. To accomplish this, the second section 6 of the main arm 1 further can be positioned in various angles and directions. More specifically, the plurality of connecting members 3 is operably coupled between the first section 5 and the second section 6 of the plurality of main arms 1, wherein operating the plurality of connectors 3 enable swiveling of the second section 6 in a plurality of directions different from that of the first section 5.

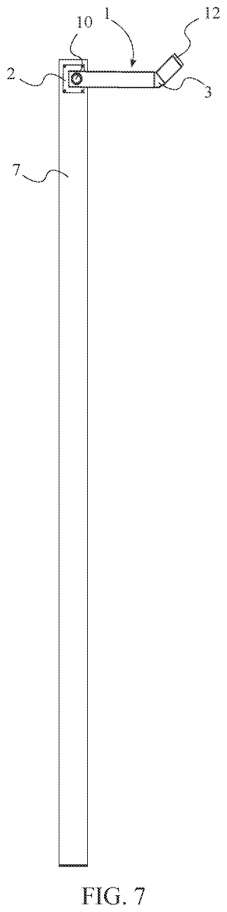

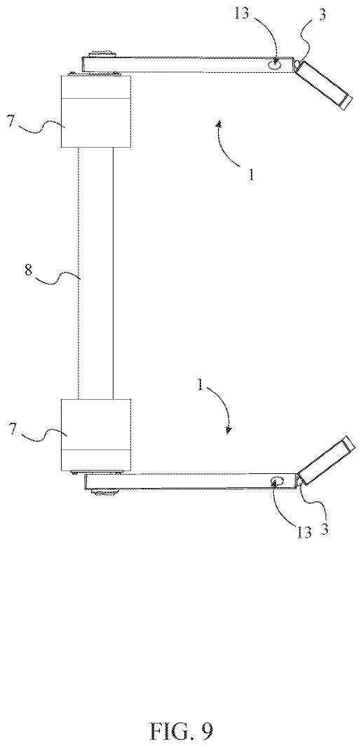

In reference to FIG. 3 through FIG. 6, the second section 6 is extended along a direction same as that of the first section 5. However, in reference to FIG. 7 and FIG. 9, the second section 6 is angularly offset from the first section 5. More specifically, in FIG. 7, the second section 6 is oriented 45 degrees away the ladder 4. In other words, the second section 6 of the main arm 1 could be locked int a 45-degree angle towards the end of the main arm 1, and this would give the main arm 1 more support when being used as a roof standoff. In FIG. 9, the second section 6 is oriented 45 degrees towards the plurality of steps 8 of the ladder 4. This position may be used when setting the ladder up on an outside corner of a wall, as the second section 6 in this orientation would stabilize the ladder while operation around corner structures as well.

As seen in FIG. 1 through FIG. 9, the present invention comprises a rubber sole 12 at the end of each of the plurality of main arms 1 such that the present invention does not scratch or create a mark with any sharp ends of the device. More specifically, the rubber sole 12 is attached to the fourth end 6b of the second section 6. Further, the rubber sole 12 may give the arm more surface friction and support when being used as a roof standoff.

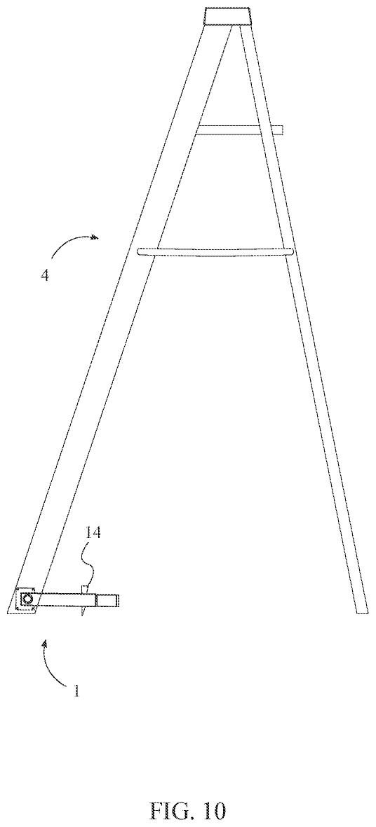

Most multi-profile ladder may be used in a few ways, such as extension mode, frame ladder mode, scaffolding mode etc. When switching from an extension ladder mode to a frame mode, the locking mechanism 10 may be unlocked and the main arm 1 may be stored in a rest position and swiveled out of the way to change the ladder configuration. Further, when using the ladder 4 in an A-frame mode, the present invention may be used for providing additional stability from the ground region. To accomplish this, the present invention comprises at least one hole 13, wherein the hole 13 traverses through the second section 6 of the main arm 1. The hole 13 may be used to thread through different kinds of fasteners or fastening mechanisms, such as ropes, clips, chains, spikes, etc. Accordingly, the present invention may comprise a fastener 14, wherein the fastener 14 is threaded through the hole 13. In reference to FIG. 10, the fastener 14 is a spike that has been threaded through the hole to fasten the ladder to the ground.

Although the invention has been explained in relation to its preferred embodiment, it is to be understood that many other possible modifications and variations can be made without departing from the spirit and scope of the invention as hereinafter claimed.

What is claimed is:

1. A multifunctional and adjustable ladder support device, comprising:
a plurality of main arms;
a plurality of mounting members;
a plurality of connecting members;
a ladder;
each of the plurality of main arms comprising a first section and a second section;
the ladder comprising a plurality of side rails;
the first section comprising a first end and a second end, wherein the first end is positioned opposite to the second end across a first length of the first section;
the second section comprising a third end and a fourth end, wherein the third end is positioned opposite to the fourth end across a second length of the second section;
each of the plurality of the mounting members being mounted between the first section of the main arm and a corresponding side rail, wherein the corresponding side rail is from the plurality of side rails;
each of the plurality of the connecting members being integrated between the second end of the first section and the third end of the second section; and
the plurality of main arms being rotatably connected to the ladder through the plurality of mounting members.

2. The multifunctional and adjustable ladder support device of claim 1, comprising:
a locking mechanism; and
the locking mechanism being operably integrated between the main arm and the ladder through the mounting member, wherein operating the locking mechanism enables locking the main arm in a plurality of different positions with respect to the plurality of siderails of the ladder.

3. The multifunctional and adjustable ladder support device of claim 2, comprising:
the locking mechanism locking the main arm in a first position, wherein the main arm is oriented parallel to the plurality of side rails;
the locking mechanism locking the main arm in a second position, wherein the main arm is oriented normal to the plurality of side rails; and
the locking mechanism locking the main arm in a third position, wherein the main arm extends in a direction away from the plurality of side rails and is parallel to the plurality of side rails.

4. The multifunctional and adjustable ladder support device of claim 1, comprising:
the plurality of connecting members being operably coupled between the first section and the second section of the plurality of main arms, wherein operating the second connector enables swiveling of the second section in a plurality of directions different from that of the first section.

5. The multifunctional and adjustable ladder support device of claim 4, wherein each of the plurality of connection members is a pivot hinge.

6. The multifunctional and adjustable ladder support device of claim 1, wherein the second section is extended along a direction same as that of the first section.

7. The multifunctional and adjustable ladder support device of claim 1, wherein the second section is angularly offset from the first section.

8. The multifunctional and adjustable ladder support device of claim 7, wherein the second section is oriented 45 degrees away from a base of the ladder.

9. The multifunctional and adjustable ladder support device of claim 7, wherein the second section is oriented 45 degrees towards steps of the ladder.

10. The multifunctional and adjustable ladder support device of claim 1, comprising:
a rubber sole; and
the rubber sole being attached to the fourth end of the second section.

11. The multifunctional and adjustable ladder support device of claim 1, comprising:
at least one hole;
the hole traversing through the second section of the main arm.

12. The multifunctional and adjustable ladder support device of claim 11, comprising:
a fastener; and
the fastener being threaded through the hole.

13. The multifunctional and adjustable ladder support device of claim 1, wherein each of the plurality of mounting members comprises a metal piece with a plurality of screws.

14. A multifunctional and adjustable ladder support device, comprising:
a plurality of main arms;
a plurality of mounting members;
a plurality of connecting members;
a ladder;
a locking mechanism;
each of the plurality of main arms comprising a first section and a second section;
the ladder comprising a plurality of side rails;
the first section comprising a first end and a second end, wherein the first end is positioned opposite to the second end across a first length of the first section;
the second section comprising a third end and a fourth end, wherein the third end is positioned opposite to the fourth end across a second length of the second section;
each of the plurality of the mounting members being mounted between the first section of the main arm and a corresponding side rail, wherein the corresponding side rail is from the plurality of side rails;
each of the plurality of the connecting members being integrated between the second end of the first section and the third end of the second section;
the plurality of main arms being rotatably connected to the ladder through the plurality of mounting members;
the locking mechanism being operably integrated between the main arm and the ladder through the mounting member, wherein operating the locking mechanism enables locking the main arm in a plurality of different positions with respect to the plurality of siderails of the ladder; and
the plurality of connecting members being operably coupled between the first section and the second section of the plurality of main arms, wherein operating the second connector enables swiveling of the second section in a plurality of directions different from that of the first section.

15. The multifunctional and adjustable ladder support device of claim 14, comprising:
the locking mechanism locking the main arm in a first position, wherein the main arm is oriented parallel to the plurality of side rails;
the locking mechanism locking the main arm in a second position, wherein the main arm is oriented normal to the plurality of side rails; and
the locking mechanism locking the main arm in a third position, wherein the main arm extends in a direction away from the plurality of side rails and is parallel to the plurality of side rails.

16. The multifunctional and adjustable ladder support device of claim 14, wherein the second section is extended along a direction same as that of the first section.

17. The multifunctional and adjustable ladder support device of claim 14, wherein the second section is angularly offset from the first section.

18. The multifunctional and adjustable ladder support device of claim 14, comprising:
a rubber sole; and
the rubber sole being attached to the fourth end of the second section.

19. The multifunctional and adjustable ladder support device of claim 14, comprising:
at least one hole; and
the hole traversing through the second section of the main arm.

20. The multifunctional and adjustable ladder support device of claim 19, comprising:
a fastener; and
the fastener being threaded through the hole.
